(19) United States
(12) Patent Application Publication
(10) Pub. No.: US 2007/0193826 A1
(43) Pub. Date: Aug. 23, 2007

(54) Adjustable ladder stabilizer

(76) Inventor: Neil Chia-chan Yang, Bellaire, TX (US)

Correspondence Address: Neil Yang, 5003 Maple St., Bellaire, TX, 77401, US

(21) Appl. No.: 11/640,745

(22) Filed: Dec. 18, 2006

Related U.S. Application Data
(63) Continuation-in-part of application No. 11/307,800, filed on Feb. 23, 2006, now abandoned.

(51) Int. Cl. E06C 7/42

(52) U.S. Cl. 182/107

(57) ABSTRACT

An Adjustable Ladder Stabilizer, comprising mainly of a vertical rod, a first slide-able piece, a second slide-able piece, and a spring; wherein the vertical rod can be attached to a ladder, the first slide-able piece, the second slide-able piece, and the spring can be slid on the vertical rod when desired; wherein the second slide-able piece has an upper inclined portion for contacting a portion of a roof, a wall, or other structure against which the ladder is put; wherein the second slide-able piece has a lower inclined portion for being biased by the spring.

### CROSS REFERENCE TO RELATED APPLICATION

This is a continuation-in-part (CIP) application of the application entitled “adjustable ladder stabilizer,” of Ser. No. 11/307,800, filed Feb. 23, 2006.

### FIELD OF THE INVENTION

This invention relates to an Adjustable Ladder Stabilizer, in particular to an Adjustable Ladder Stabilizer of which the height can be adjusted.

### BACKGROUND OF THE INVENTION

Most of the conventional ladders have their lower end put on the ground and have two points or portions on their forward side contact or rest against an edge of a structure (e.g. an edge of a roof of a building or a top portion of a wall). The ladder relies on the friction between the ladder and the structure to prevent itself from sliding off to either right side or left side. However, this friction is often not sufficient especially when the ground is not firm enough or if the ladder is not positioned correctly.

Ellinger's U.S. Pat. No. 799,782 and Yang et al.'s U.S. patent application Publication No. 2004/0140155 depict two examples of ladder stabilizer.

### SUMMARY OF THE PRESENT INVENTION

One objective of the present invention is to provide an Adjustable Ladder Stabilizer which can be easily attached or installed on a ladder, and which can greatly stabilize a ladder.

Another objective of the present invention is to provide an Adjustable Ladder Stabilizer of which the height can be adjusted easily.

### BRIEF DESCRIPTION OF THE DRAWINGS

FIG. 1 is a side view illustrating a preferred embodiment of the Adjustable Ladder Stabilizer of the present invention;

FIG. 2 is a side view of a second sliding piece used in the present invention;

FIG. 3 is a top view of the second sliding piece used in the present invention;

FIG. 4 is a side view of a first sliding piece used in the present invention;

FIG. 5 is a top view of the second sliding piece used in the present invention; and

FIG. 6 is a perspective view showing an example of the installation of the present invention on a ladder.

### DETAILED DESCRIPTION OF THE DRAWINGS

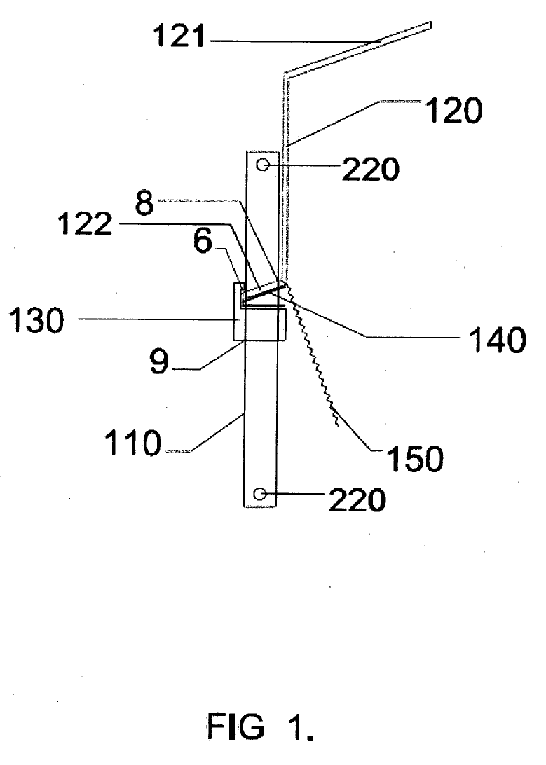

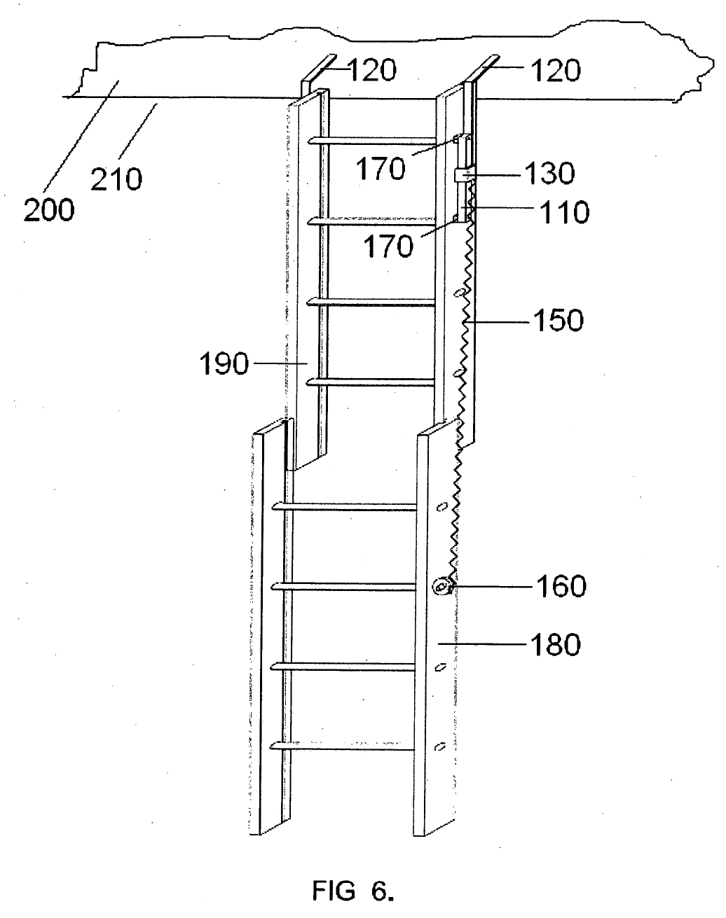

The Adjustable Ladder Stabilizer of the present invention comprises mainly a vertical rod 110, a first slide-able piece 130, a second slide-able piece 120, and a spring 140. The vertical rod 110 can be provided with two spacers 170 (as shown in FIG. 6). The vertical rod 110 and the spacers 170 are provided with two threaded holes 220 (as shown in FIG. 1) so as to be installed to a ladder (this ladder can be any conventional ladder, in the example shown in FIG. 6, it has a lower part ladder 180, and an upper part ladder 190) with bolts (not shown in the drawings). A line (which can be a rope, string, tape, chain or the like) 150 can be attached to the second slide-able piece 120.

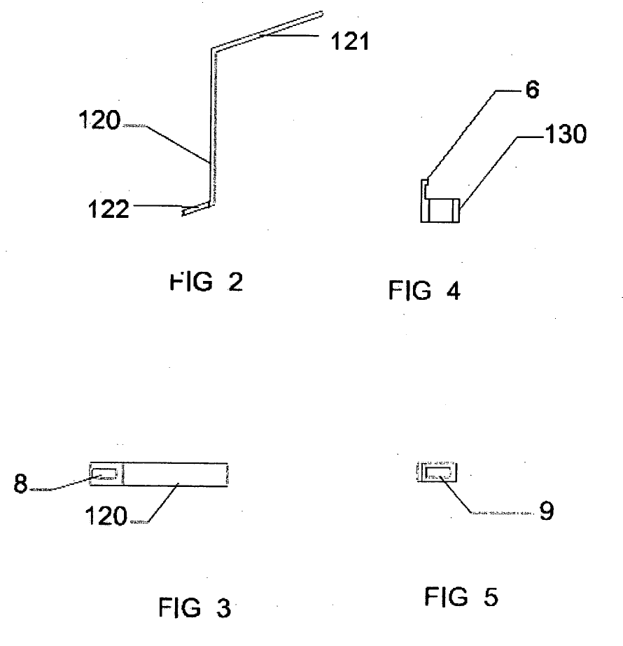

The first slide-able piece 130 is provided with an opening 9 (FIG. 5) and a protrusion 6 (FIGS. 4,1); the second slide-able piece 120 is provided with an opening 8 (FIG. 3), the spring 140 can also be provided with similar openings (not shown in the drawings). The openings 8, 9, and the two openings on the spring 140 accommodate the vertical rod 110 so that the first slide-able piece 130, the second slide-able piece 120, and the spring 140 can be slide-able on the vertical rod 110, when desired.

The second slide-able piece 120 has an upper inclined portion 121 and a lower inclined portion 122; the line 150 can have its upper end attached to the upper end of the lower inclined portion 122. The lower portion of the line 150 can be accommodated in a rewind-able reel 160 which can be fastened on the lower part ladder 180, so that the line 150 can be extended or retracted when desired.

The upper part ladder 190 can be put against a lower edge 210 of a roof 200.

The spring 140 is of a shape of “<” when viewed sidewise. The upper portion of the spring 140 can bias against the lower face of the lower inclined portion 122 of the second slide-able piece 120, which turn biases against the face of the vertical rod 110 contacting the second slide-able piece 120. The first slide-able piece 130 has its protrusion 6 engaged with the lower end of the lower inclined portion 122 so that the first slide-able piece 130 and the spring 140 can be prevented from moving downwardly, and thus the Adjustable Ladder Stabilizer can be locked in place because of the friction between the vertical rod 110 and the second slide-able piece 120.

When the upper part ladder 190 is put against e.g. the lower edge 210 of the roof surface 200 (FIG. 6), if the position of the upper inclined portion 121 is higher than the roof surface 200, then the line 150 can be pulled down so that the upper portion of the spring 140 can be released from the position biasing against the lower inclined portion 122, thus the second slide-able piece 120, the first slide-able piece 130, and the spring 140 can be slid down until the lower face of the upper inclined portion 121 contacts the roof surface 200. When the user steps on the lower part ladder 180 or the upper part ladder 190, the upper inclined portion 121 is further biased against the roof surface 200, thus the friction force between the second slide-able piece 120 and the vertical rod 110 is tremendously increased, and therefore the upper part ladder 190 can be prevented from moving sidewise, and the safety of the user can be significantly enhanced.

The vertical rod 110 (shown in FIGS. 1 & 6) can be longer than that shown in FIGS. 1 & 6, when necessary. The roof surface 200 and the lower edge 210 of the roof can be replaced with a wall or other structure (not shown in the drawings) when in use. The upper inclined portion 121 can be put against the upper edge of the wall. The lower face of the upper inclined portion 121 can be attached with a piece of uneven rubber or other high-friction material to reinforce stability. The lower part ladder 180 and the upper part ladder 190 can be replaced with other kinds of ladders. The spacers 170 and the vertical rod 110 can be installed to the ladder using welding or other means.

1) An Adjustable Ladder Stabilizer, comprising mainly of a vertical rod, a first slide-able piece, a second slide-able piece, and a spring; wherein the vertical rod can be attached to a ladder, the first slide-able piece, the second slide-able piece, and the spring can be slid on the vertical rod when desired; wherein the second slide-able piece has an upper inclined portion for contacting a portion of a roof, a wall, or other structure against which the ladder is put; wherein the second slide-able piece has a lower inclined portion for being biased by the spring.

2) The Adjustable Ladder Stabilizer according to claim 1, further comprising a line having its upper end attached to the second slide-able piece, and having its lower portion accommodated in a rewind-able reel.

3) The Adjustable Ladder Stabilizer according to claim 1 further comprises of at least one spacer between the vertical rod and the ladder.
